(19) United States
(12) Patent Application Publication
(10) Pub. No.: US 2024/0007407 A1
(43) Pub. Date: Jan. 4, 2024

(54) TUNNELING OF SHORT-RANGE SENSOR DATA THROUGH LONG-RANGE WIRELESS TECHNOLOGY

(71) Applicant: Morgen Technology Inc., Chagrin Falls, OH (US)

(72) Inventors: Mike Smith, Chagrin Falls, OH (US); Patrick Mause, Chagrin Falls, OH (US); Mike Murphy, Chagrin Falls, OH (US)

(21) Appl. No.: 18/346,373

(22) Filed: Jul. 3, 2023

Related U.S. Application Data
(60) Provisional application No. 63/358,182, filed on Jul. 4, 2022.

(51) Int. Cl. H04L 47/2425; H04L 41/0604; H04L 67/12

(52) U.S. Cl. CPC H04L 47/2433; H04L 41/0609; H04L 67/12

(57) ABSTRACT

Various technologies described herein pertain to methods and systems for receiving and transmitting sensor data packets for use in a property management system. Local sensors transmit sensor data packets containing sensor data information relating to an environment via a first communication protocol. A gateway computing system receives the sensor data packets and stores the sensor data packets in a sensor data queue. The sensor data packets are assigned one or more priority labels. One or more sensor data packets are appended into an aggregate sensor data message based upon the priority labels and the message is transmitted via a second communication protocol. A centralized property management computing system receives the aggregate sensor data messages, generates an output indicative of the conditions in the sensed environment, and may execute a property control operation in the sensed environment.

### CROSS-REFERENCE TO RELATED APPLICATION

This application claims priority to United States Provisional Patent Application No. 63/358,182, filed on Jul. 4, 2022, and entitled “TUNNELING OF SHORT-RANGE SENSOR DATA THROUGH LONG-RANGE WIRELESS TECHNOLOGY”, the entirety of which is incorporated herein by reference.

### TECHNICAL FIELD

Aspects of the disclosed technology relate to methods and systems for transmitting sensor data and, more particularly, to systems and methods for tunneling short range sensor data through long range wireless technology.

### BACKGROUND OF THE INVENTION

In connection with monitoring a building, property, or environment, one or more sensors are deployed to sense or detect one or more conditions in the location. For example, multiple sensors may be used in a property management system to monitor one or more values or conditions in an environment, such as in a building. Each sensor detects or collects information about the environment and transmits the collected information. Sensors may collect information regarding a number of values or conditions, such as temperature, humidity, smoke, air quality, water presence, pressure, proximity, and the like. The transmitted information may then be used by a centralized property management computing system to monitor, manage, and/or control the property.

Conventionally, sensors used in property management systems are short-range sensors capable of transmitting collected data only a short distance, such as within the house in which the sensor is disposed. Thus, conventional systems typically require one or more base stations or gateways within the environment to upload the collected information to the property management system, and multiple base stations or gateways are often required for larger buildings. The base stations or gateways often then relay the collected information to a nearby centralized property management computing system within the range of the base station or gateway, or the base stations or gateways upload the information to the centralized property management computing system, such as via the Internet.

Long-range sensors, such as sensors capable of transmitting information over miles, have become available for use in building systems. However, long-range sensors may be difficult to acquire and install. In addition, many buildings are already fitted with short-range sensors and refitting buildings with new long-range sensors is difficult and expensive.

Further, as long-range sensor transmissions have a larger coverage area than conventional short-range sensors, long-range signals are more likely to collide or interfere with other signals, objects, devices, or structures. Accordingly, the transmissions from long-range sensors often collide with and provide noise or interference for other sensors or transmissions and decrease the efficacy of the transmitted signal. Additionally, long-range sensors are more regulated by the Federal Communications Commission (FCC) and other regulatory bodies and the transmission rate of long-range sensors is lower than for short-range transmissions.

It is therefore appreciated that a need exists for an improved communication or transmission system for sensors used as part of property management systems that is simple, accessible, efficient, and effective. In view of the above, there is an unmet need for systems, methods, and apparatuses for transmitting sensor information in a property management system.

### SUMMARY

The following is a brief summary of the subject matter that is described in greater detail herein. The summary is not intended to be limiting as to the scope of the claims.

This summary is meant to provide some examples and is not intended to be limiting of the scope of the invention in any way. For example, any feature included in an example of this summary is not required by the claims, unless the claims explicitly recite the features. Also, the features, components, steps, concepts, etc. described in examples in this summary and elsewhere in this disclosure can be combined in a variety of ways. Various features and steps as described elsewhere in this disclosure can be included in the examples summarized here.

In one embodiment, a gateway computing system for use in a property management system is disclosed. The gateway computing system includes a processor configured to receive sensor data packets via a first communication protocol, store the sensor data packets in a sensor data queue, assign a priority label to each sensor data packet stored in the sensor data queue based upon the contents of the sensor data packets, generate an aggregate sensor data message by appending sensor data packets stored in the sensor data queue based upon the priority labels of the sensor data packets, and transmit the aggregate sensor data message via a second communication protocol. The first communication protocol is different from the second communication protocol.

In another embodiment, a method for transmitting sensor data packets for use in a property management system is disclosed. The method includes receiving a plurality of sensor data packets via a first communication protocol, storing the plurality of sensor data packets in a sensor data queue, forming an aggregate sensor data message comprising at least two of the plurality of sensor data packets, and transmitting the aggregate sensor data message via a second communication protocol. The first communication protocol has a first coverage range and the second communication protocol has a second coverage range. the second coverage range is larger than the first coverage range.

In another embodiment, a method for transmitting sensor data packets for use in a property management system is disclosed. The method includes receiving sensor data packets via a first communication protocol, storing the sensor data packets in a sensor data queue, assigning a priority label to each sensor data packet stored in the sensor data queue based upon the contents of the sensor data packets, generating an aggregate sensor data message by appending sensor data packets stored in the sensor data queue based upon the priority label of the sensor data packet, and transmitting the aggregate sensor data message via a second communication protocol. The second communication protocol is different from the first communication protocol.

The above summary presents a simplified summary in order to provide a basic understanding of some aspects of the systems and/or methods discussed herein. This summary is not an extensive overview of the systems and/or methods discussed herein. It is not intended to identify key-critical elements or to delineate the scope of such systems and/or methods. Its sole purpose is to present some concepts in a simplified form as a prelude to the more detailed description that is presented later.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention. It will be appreciated that illustrated element boundaries (e.g., boxes, groups of boxes, or other shapes) in the figures represent only one exemplary embodiment of boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 is a functional block diagram of an exemplary property management system;

FIG. 2a is a functional block diagram illustrating data communication within the centralized property management computing system of FIG. 1 according to one embodiment;

FIG. 2b is a functional block diagram illustrating data communication within the centralized property management computing system of FIG. 1 according to another embodiment;

FIG. 3 is a flow diagram illustrating a method for receiving sensor data packets via a first communication protocol and transmitting an aggregate sensor data message via a second communication protocol;

FIG. 4 is a flow diagram illustrating a method for prioritizing sensor data packets and generating an aggregate sensor data message; and

FIG. 5 is a flow diagram illustrating a method for controlling a property based upon sensor information.

### DETAILED DESCRIPTION

Various technologies pertaining to transmitting sensor data, including the tunneling of short-range sensor data through long-range wireless technology, as part of a property management system are now described with reference to the drawings. The accompanying drawings illustrate specific embodiments of the present disclosure. Other embodiments having different structures and/or operations do not depart from the scope of the present disclosure.

In the following description, for purposes of explanation, numerous specific details are set forth in order to provide a thorough understanding of one or more aspects. It may be evidence, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The following includes definitions of exemplary terms that may be used throughout the disclosure Both singular and plural forms of all terms fall within each meaning.

“Component” and “system,” as used herein, are intended to encompass computer-readable data storage that is configured with computer-executable instructions that cause certain functionality to be performed when executed by a processor. The computer-executable instructions may include a routine, a function, or the like. It is also to be understood that a component or system may be located on a single device or distributed across several devices, such as a combination of hardware, software, or a portion thereof. A component may be associated with a device. It is appreciated that components may include at least a processor and a memory, wherein the processor is configured to execute one or more instructions stored in the memory.

“Computer” or “processor,” as used herein includes, but is not limited to, one or more programmed or programmable electronic device or coordinated devices that can store, retrieve, and process data and may be any processing unit, distributed processing configuration, or processor systems. Examples of processor include microprocessors, microcontrollers, central processing units (CPUs), graphics processing units (GPUs), tensor processing unit (TPU), floating point units (FPUs), reduced instruction set computing (RISC) processors, digital signal processors (DSPs), field programmable gate arrays (FPGAs), system-on-module (SOMs), etc., in any combination. One or more cores of a single microprocessor and/or multiple microprocessor each having one or more cores can be used to perform the operation as being executed by a processor herein. The processor can also be a processor dedicated to the training of neural networks and other artificial intelligence (AI) systems. The processor may be associated with various other circuits that support operation in the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or drawings.

“Network interface” or “data interface,” as used herein includes, but is not limited to, any interface or protocol for transmitting and receiving data between electronic devices. The network or data interface can refer to a connection to a computer via a local network or through the internet and can also refer to a connection to a portable device—e.g., a mobile device or a USB thumb drive—via a wired or wireless connection. A network interface can be used to form networks of computers to facilitate distributed and/or remote computing (i.e., cloud-based computing). “Cloud-based computing” means computing that is implemented on a network of computing devices that are remotely connected to the device via a network interface.

“Signal,” as used herein includes, but is not limited to, one or more electric signals, including analog or digital signals, one or more computer instructions, a bit or bit stream, or the like.

“Logic,” synonymous with “circuit” as used herein, includes but is not limited to hardware, firmware, software and/or combinations of each to perform a function(s) or action(s). For example, based on one or more desired applications or needs, logic may include a software-controlled microprocessor, discrete logic such as an application specific integrated circuit (ASIC), or other programmed logic device and/or controller. Logic may also be fully embodied as software.

“Software,” as used herein includes, but is not limited to, one or more computer readable and/or executable instructions that cause a computer, processor, logic, and/or other electronic device to perform functions, actions, and/or behave in a desired manner. The instruments may be embodied in various forms such as routines, algorithms, modules, or programs including separate applications or code from dynamically linked sources or libraries (DLLs). Software may also be implemented in various forms such as a stand-alone program, a web-based program, a function call, a subroutine, a servlet, an application, an app, an applet (e.g., a Java applet), a plug-in, instructions stored in a memory, part of an operating system, or other type of executable instructions or interpreted instructions from which executable instructions are created.

“Module” or “engine” as used herein will be appreciated as comprising various configurations of computer hardware and/or software implemented to perform operations. In some embodiments, modules or engines as described herein may be represented as instructions operable to be executed by a processor in a processor or memory. In other embodiments, modules or engines as described herein may be represented as instructions read or executed from readable media. A module or engine may operate in either hardware or software according to application specific parameters or user settings. It will be appreciated by those of skill in the art that such configurations of hardware and software may vary, but remain operable in substantially similar ways.

“Data storage device,” as used herein includes, but is not limited to, a device or devices for non-transitory storage of code or data, e.g., a device with a non-transitory computer readable medium. As used herein, “non-transitory computer readable medium” means any suitable non-transitory computer readable medium for storing code or data, such as a magnetic medium, e.g., fixed disks in external hard drives, fixed disks in internal hard drives, and flexible disks; an optical medium, e.g., CD disk, DVD disk; and other media, e.g., ROM, PROM, EPROM, EEPROM, flash PROM, external memory drives, etc.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean “serving as an illustration or example of something.”

While the above exemplary definitions have been provided, it is Applicant's intention that the broadest reasonable interpretation consistent with this specification be used for these and other terms. Aspects and implementations of the present disclosure will be understood more fully from the detailed description given below and from the accompanying drawings of the various aspects and implementations of the disclosure. This should not be taken to limit the disclosure to the specific aspects or implementations, but explanation and understanding only.

The following description refers to the accompanying drawings, which illustrate specific embodiments of the present disclosure. Other embodiments having different structures and/or operation do not depart from the scope of the present disclosure. The descriptions of the invention do not limit the words used in the claims in any way or the scope of the claims or invention. The words used in the claims have all of their full ordinary meanings.

The property management system described herein exhibits various advantages over conventional property management sensor systems utilized in buildings in that sensor data from short-ranges sensors are tunneled through a long-range wireless technology; this is in contrast to utilizing short-range sensors only, which may be incapable of transmitting sensor data to centralized property management computing systems, or replacing all short-range sensors in a system with long-range wireless sensors, which may be costly, increase noise, and not transmit data sufficiently.

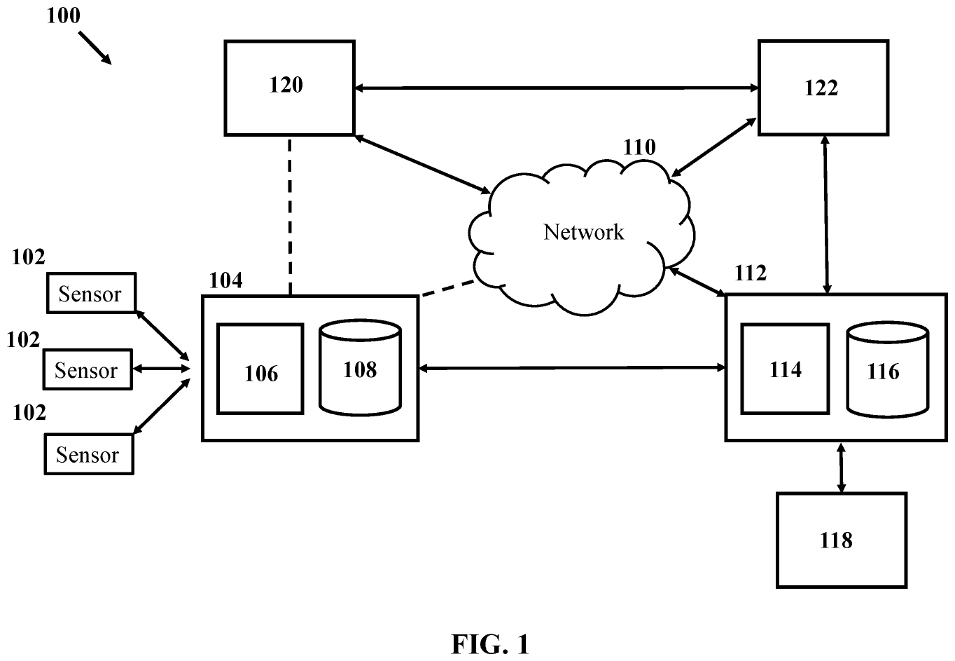

FIG. 1 shows an exemplary property management system 100 of the present disclosure. The system 100 includes one or more local sensors 102 in data communication with a gateway computing system 104. The sensor(s) 102 are configured to monitor or detect one or more conditions in a desired space, location, or environment, such as within a building. Each sensor 102 may monitor or detect one or more conditions in the respective environment, such as temperature, humidity, occupancy, presence of smoke or fire, or other condition in an area surrounding the sensor 102, such as in a room, hallway, or stairway. The sensors 102 may be disposed or deployed anywhere in and around the desired environment, such as a building, and may be any type of sensors or devices used in residential or commercial buildings capable of collecting or generating data based upon the surrounding area or environment. For example, the one or more sensors 102 may be sensors or devices for monitoring residential or commercial buildings such as one or more of the following: temperature sensors, humidity sensors, motion or occupancy sensors, contact sensors, gas or air quality sensors, smoke sensors, level sensors, electrical current monitoring sensors, pressure sensors, water leak sensors, image sensors, rodent or pest detection sensors, fluid flow sensors, location sensors, object counting sensors, people counting sensors, vibration sensors, movement sensors, acceleration sensors, or other similar sensor. The sensors 102 are configured to generate sensor data in the form of sensor data packets in real time, near real-time, continuously, periodically, upon a change in a detected variable or value, and/or upon detection of an event or condition. For example, each sensor 102 may generate sensor data each time a sensed value, such as temperature or humidity level, changes and/or may generate sensor data at periodic intervals.

The sensors 102 are also configured to transmit the generated sensor data according to a first communication protocol such that the first communication protocol transmission is transmitted within an area surrounding the sensor 102, such as within the sensed building. In some embodiments, the first communication protocol has a transmission range between about 5 to about 300 feet, such as between about 50 to about 100 feet. In some embodiments, the first communication protocol is a short-range wireless communication protocol. For example, the first communication protocol may also be short-range radio, short-range cellular, infrared, WiFi, near field communication, ultraband, Bluetooth, ZigBee, EnOcean, Z-wave, etc. In the illustrated embodiment, the system 100 includes three sensors 102 in data communication with the gateway computing system 104. However, it will be appreciated that the system 100 may include any number of sensors 102. For example, the system 100 may include one, two, or four or more sensors 102 in data communication with the gateway computing system 104 such that the sensors 102 sufficiently monitor or sense the desired space, location, or environment.

Each sensor 102 may generate the sensor data as a sensor data packet which is transmitted from the sensor 102 according to the first communication protocol. Each sensor data packet may include a variety of information relating to the sensed area or environment. Each sensor data packet may include one or more current sensed values, one or more previous sensed values, and/or time stamps corresponding to the sensed values. The current and/or previous sensed values may relate to one or more values or sensed values, variables, or conditions. For example, one of the sensors may be configured to sense humidity and temperature and upon detection of a change in temperature, the sensor may generate a sensor data packet including the previous humidity and temperature values, the current humidity and temperature values, and time stamps corresponding to the previous and current values. The sensor 102 may then be configured to transmit the generated sensor data packet according to the first communication protocol. The sensors 102 may generate and transmit the sensor data packets at predetermined times, such as upon predetermined intervals, or upon detection of a change in value of one of the sensed conditions. The sensors 102 may generate the sensor data packets independently from the transmission of the sensor data packets. For example, the sensors 102 may generate the sensor data packets upon a change in one or more sensed values and may transmit the sensor data packets at periodic intervals, such as including all sensor data packets generated during the interval or including only the most recently generated sensor data packet.

The gateway computing system 104 includes at least one processor 106 and a memory 108 in data communication with one another. The at least one processor 106 executes instructions that are stored in the memory 108. The instructions may be, for instance, instructions for implementing functionality described as being carried out by one or more systems discussed below or instructions for one or more of the methods described below. The processor 106 may be a GPU, a plurality of GPUs, a CPU, a plurality of CPUs, a multi-core processor, a controller, a micro-controller, a SOM, etc. The processor 106 may access the memory 108 by way of a system bus. In addition to storing instructions, the memory 108 may also store building or environment data, sensor data, data related to the type, accuracy, sensitivity, and location of sensors, and so forth. The gateway computing system 104 is configured to receive the sensor data packets transmitted via the first communication protocol and tunnel sensor data through a long-range wireless technology. In some embodiments, the gateway computing system 104 is configured to receive sensor data from one or more sensors 102 according to the first communication protocol as input, generate or form an aggregate sensor data message, and transmit the aggregate sensor data message according to a second communication protocol, as described below. In some embodiments, the gateway computing system 104 is also configured to generate sensor data packets by aggregating and/or converting sensor data from two or more received sensor data packets.

The gateway computing system 104 is configured to receive and store the received sensor data packets in a sensor data queue, such as in the memory 108. The gateway computing system 104 may be disposed within the first communication protocol coverage area or transmission range from each of the sensors 102 such that the gateway computing system 104 may receive the sensor data packets transmitted by each of the sensors 102 via the first communication protocol. The gateway computing system 104 may be disposed in the same space, location, or environment as the sensors 102, such as in the same building, and may receive sensor data packets transmitted from one or more of the sensors 102 in the space, location, or environment, such as all the sensors 102 in the space, location, or environment. The gateway computing system 104 may append and/or store some or all of the received sensor data packets in the sensor data queue. Additionally, the gateway computing system 104 may be configured to receive sensor packet transmissions from one or more sensors 102 previously installed or disposed in the environment.

In the illustrated embodiment, the system 100 includes one gateway computing system 104 which receives sensor data packet transmissions from each of the sensors 102 in the space, location, or environment. However, the system 100 may include any number of gateway computing systems 104. For example, the system 100 may include two or more gateway computing systems 104 which each receive data packet transmissions from a subset of sensors 102 in the system 100. For example, the system 100 may include a first gateway computing system 104 associated with a first subset of sensors 102, such as sensors 102 located in a first floor, first portion of a building, or first building, and a second gateway computing system 104 associated with a second subset of sensors 102, such as sensors 102 located in a second floor, second portion of a building, or second building.

The gateway computing system 104 may be configured to analyze and/or process the sensor data in the received and/or stored sensor data packets. The gateway computing system 104 may be configured to aggregate and/or convert sensor data contained in two or more sensor data packets into one or more new sensor data packets. The gateway computing system 104 may be configured to aggregate and/or convert sensor data indicative of a sensed condition and contained in received sensor data packets and/or stored sensor data packets into one or more new sensor data packets with sensor data indicative of the aggregated and/or converted sensor data, such as sensor data packets with sensor data indicative of the rate of change of the sensed condition. For example, the gateway computing system 104 may receive and/or store two or more sensor data packets containing sensor data indicative of power usage levels (e.g., amperage levels), such as from one or more power meter type sensors 102, and the gateway computing system 104 may be configured to aggregate and/or convert the sensor data into one or more sensor data packets with sensor data indicative of power usage rates (e.g., kilowatt hours).

The gateway computing system 104 may also be configured to parse, delete, or remove information contained in the received sensor data packets and stored in the sensor data queue. For example, the gateway computing system 104 may delete portions of sensor data packets which do not contain relevant updates pertaining to sensed values. For example, when the gateway computing system 104 receives a sensor data packet containing changes in one sensed value and the other sensed values remain static or the same, the gateway computing system 104 may be configured to delete the portions of the sensor data packets corresponding to the sensed value that remained static or the same. Additionally, the gateway computing system 104 may also delete or remove information contained in sensor data packets in the sensor data queue which are redundant. The gateway computing system 104 may be configured to delete sensor data packets received from one of the sensors 102 when subsequent sensor data packets are received from one of the sensors 102, such as the same sensor 102, rendering the first sensor data packet redundant. For example, the gateway computing system 104 may be configured to delete a first received sensor data packet received from one of the sensors 102 indicative of a change in temperature after the gateway computing system 104 receives a subsequent sensor data packet from the same sensor 102 indicating that the sensed temperature has returned to the original state or that the new sensed temperature has changed further. In embodiments in which the gateway computing system 104 aggregates and/or converts sensor data from two or more sensor data packets into one or more new sensor data packets, the gateway computing system 104 may also be configured to delete or remove the sensor data contained in the sensor data packets which were aggregated and/or converted into the new sensor data packets.

In some embodiments, the gateway computing system 104 may be configured to detect sensor data contained in sensor data packets which do not contain relevant updates pertaining to sensed values based upon a predetermined threshold or tolerance. The predetermined tolerance may be preset by a user and may correspond to an amount or percentage that a sensed value may change to be a relevant change. The gateway computing system 104 may compare the newly received sensor data information to sensor data information contained in one or more stored sensor data packets based upon the predetermined tolerance to determine whether the newly received sensor data information contains relevant information and/or is indicative of a static condition. According to an illustration, the gateway computing system 104 may compare the newly received sensor data information to sensor data information that was previously received by the gateway computing system 104 and/or reported from the gateway computing system 104. For example, the gateway computing system 104 may compare the newly received sensor data information to sensor data information contained in one or more stored sensor data packets and may delete or remove the sensor data contained in the stored sensor data packet(s) when the change in sensed value contained in the newly received sensor data packet is less than the predetermined tolerance and may append the newly received sensor data packet to the sensor data queue when the change in sensed value contained in the newly received sensor data packet is greater than or equal to the predetermined threshold. The gateway computing system 104 is also configured to append, manipulate, remove, and prioritize the sensor data packets received from the sensors 102 via the first communication protocol and contained in the sensor data queue to generate an aggregate sensor data message including one or more received sensor data packets and/or the information contained in one or more received sensor data packets. The gateway computing system 104 may be configured to append, manipulate, remove, and prioritize the sensor data packets in the sensor data queue based on their contents, relevance, importance, and/or other suitable factors. The gateway computing system 104 is configured to assign one or more priority tags or labels to the sensor data packets stored in the sensor data queue to determine and assign an overall priority or order for the sensor data packets stored in the sensor data queue. In some embodiments, the gateway computing system 104 may assign one or more priority labels to the sensor data packets in the sensor data queue based upon their contents and weight the one or more priority labels to determine and assign the overall priority for the sensor data packets stored in the queue. In other embodiments, the gateway computing system 104 may evaluate the contents of each of the sensor data packets according to one or more metrics to determine the overall priority for the sensor data packets stored in the queue.

In one embodiment, the gateway computing system 104 may assign a first priority label to sensor data packets stored in the sensor data queue based upon the type of condition sensed in the sensor data packet. The gateway computing system 104 may assign a relatively high first priority tag to conditions requiring immediate action or attention, such as fire or flooding, and assign a relatively low first priority tag to conditions which do not require immediate action or attention, such as a slight change in the humidity of an environment. The gateway computing system 104 may assign a second priority label to sensor data packets stored in the sensor data queue based upon an amount a sensed value changed. The gateway computing system 104 may assign a relatively high second priority tag to large changes in sensed values and a relatively low second priority tag to minor or trivial changes in sensed values. The gateway computing system 104 may assign a third priority label to sensor data packets stored in the sensor data queue based upon a delay or amount of time that the data packet has remained in the sensor data queue without being transmitted by the gateway computing system 104. The gateway computing system 104 may assign a relatively high third priority tag to sensor data packets which have remained in the sensor data queue for a long time and a relatively low third priority tag to sensor data packets which have recently been received by the gateway computing system 104. For example, the gateway computing system 104 may assign a relatively high first priority label to sensor data packets indicative of calamities, such as smoke, fire, or water damage, may assign a relatively low second priority label to sensor data packets indicative of minor changes in the environment, such as slight variations in temperature or humidity, and may assign a relatively high third priority label to sensor data packets which have remained in the sensor data queue after multiple transmissions from the gateway computing system 104. The gateway computing system 104 may assign first, second, and third priority labels according to multiple levels or buckets, such as according to high, medium, and low levels, or any other suitable classification. The gateway computing system 104 may then determine and assign an overall priority for each of the sensor data packets based upon one or more of the assigned priority labels, such as by weighting each of the assigned priority labels.

In another embodiment, the gateway computing system 104 is configured to determine and assign the overall priority for each of the sensor data packets in the sensor data queue by simultaneously weighting or evaluating the contents of each sensor data packet. For example, the gateway computing system 104 may be configured to determine the overall priority for each of the sensor data packets by simultaneously weighting or evaluating the type of condition sensed in each sensor data packet, the amount a sensed value changed in each sensor data packet, and the amount of time the sensor data packet has remained in the sensor data queue without being transmitted.

The gateway computing system 104 is then configured to reorder or reorganize the sensor data packets stored in the sensor data queue based upon one or more of the assigned priority labels and/or the overall priorities for each of the sensor data packets contained in the sensor data queue. In some embodiments, the gateway computing system 104 may reorder the sensor data packets in the sensor data queue such that sensor data packets assigned with the highest first, second, and/or third priority labels are placed near the top of the sensor data queue and sensor data packets assigned with lowest first, second, and third priority labels are near the bottom of the sensor data queue. In other embodiments, the gateway computing system 104 may reorder the sensor data packets in the sensor data queue such that the sensor data packets with the highest overall priority are placed near the top of the sensor data queue and the sensor data packets with the lowest overall priority are near the bottom of the sensor data queue.

The gateway computing system 104 is also configured to generate an aggregate sensor data message comprising one or more sensor data packets received via the first communication protocol and stored in the sensor data queue. The gateway computing system 104 may aggregate, append, or combine the manipulated sensor data packets contained in the sensor data queue into the aggregate sensor data message based upon the assigned priorities and/or overall priorities, such as by appending or combining the sensor data packets with the highest assigned priority and/or overall priority first and/or the sensor data packets at the top of the sensor data queue. The gateway computing system 104 may aggregate, append, or combine one or more sensor data packets into an aggregate sensor data message that the gateway computing system 104 may transmit by a second communication protocol, as described below. For example, the gateway computing system 104 may aggregate, append, or combine a number of sensor data packets in the data sensor queue with the highest priorities and/or overall priorities into an aggregate sensor message such that the aggregate sensor data message is a size which may be transmitted by the second communication protocol.

The gateway computing system 104 is also configured to transmit the aggregate sensor data message via a second communication protocol that is different from the first communication protocol and capable of transmitting farther than the first communication protocol. In one embodiment, the second communication protocol is a long-range wireless communication protocol, such as a long-range radio communication protocol, having a range between about 0.1 and about 30 miles, such as between about 0.5 miles and about 2 miles. Further, after the gateway computing system 104 has transmitted the aggregate sensor data message via the second communication protocol, the gateway computing system 104 may be configured to remove the sensor data packets contained in the aggregate sensor data message from the sensor data queue.

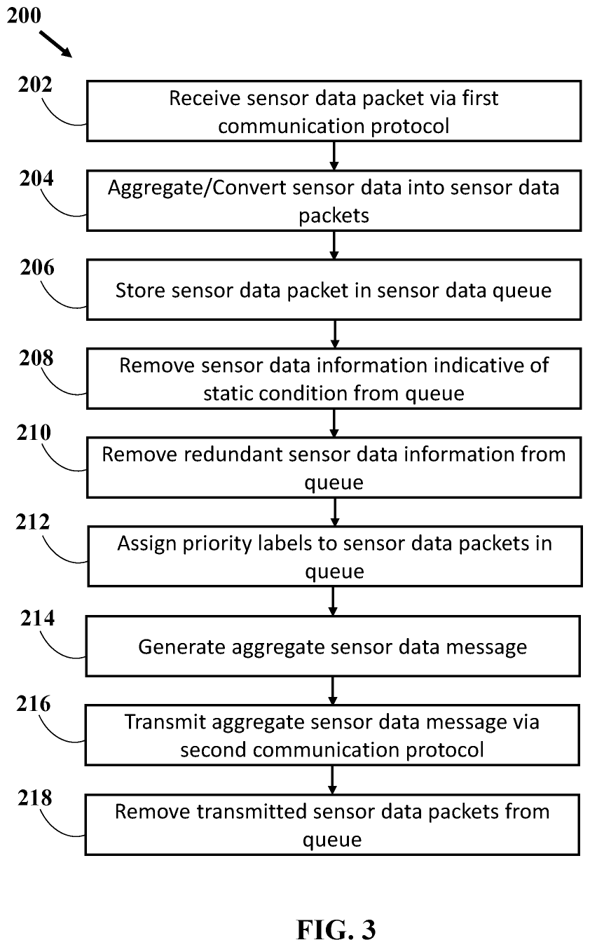

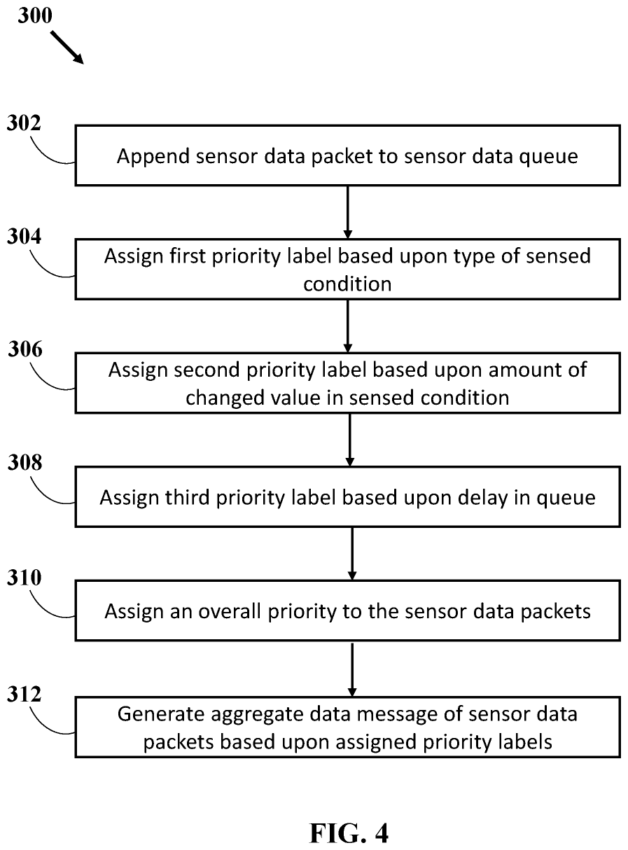

FIGS. 3 and 4 illustrate exemplary methodologies relating to prioritizing and transmitting sensor data. While the methodologies shown as being a series of acts that are performed in sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, sub-routine, programs, a thread of execution, and/or the like. Still further, the results of acts of the methodologies can be stored in a computer-readable medium, displayed on a display device, and/or the like.

FIG. 3 shows steps according to an exemplary method 200 for receiving sensor data packets via a first communication protocol and transmitting an aggregate sensor data message via a second communication protocol. It will be appreciated that the illustrated method and associated steps may be performed in a different order, with illustrated steps omitted, with additional steps added, or with a combination of reordered, combined, omitted, or additional steps. The steps may be implemented in one or more computer readable instructions, such as by the gateway computing system 104.

At step 202, one or more sensor data packets containing sensor data information indicative of sensed conditions in an environment, such as a house or building, can be received. The gateway computing system 104 receives sensor data information in the form of sensor data packets transmitted by one or more sensors 102 in an environment via a first communication protocol, such as a short-range wireless communication protocol. The sensor data packets may contain information indicative of current and/or updated sensed conditions in an environment.

At step 204, sensor data contained in one or more received sensor data packets may optionally be aggregated and/or converted into additional sensor data packets. The gateway computing system 104 may be configured to aggregate and/or convert sensor data contained in two or more sensor data packets into one or more new sensor data packets. The gateway computing system 104 may be configured to aggregate and/or convert sensor data indicative of a sensed condition and contained in received sensor data packets and/or stored sensor data packets into one or more new sensor data packets with sensor data indicative of the aggregated and/or converted sensor data, such as sensor data packets with sensor data indicative of the rate of change of the sensed condition. For example, the gateway computing system 104 may receive two or more sensor data packets containing sensor data indicative of power usage levels and aggregate and/or convert the power usage levels into one or more sensor data packets indicative of power usage rate(s). In some embodiments, after the gateway computing system 104 has aggregated and/or converted the received sensor data packets into one or more new sensor data packets, the gateway computing system 104 may delete the original sensor data information and/or the original sensor data packets.

At step 206, the sensor data packets are added or amended to or stored in a sensor data queue. The gateway computing system 104 may store the received sensor data packets in the sensor data queue in the memory 108 of the gateway computing system 104. The gateway computing system 104 may store the sensor data packets directly in the sensor data queue or may pre-process and/or process the sensor data packets before storing the sensor data packets, or information contained therein, in the sensor data queue, such as by cleaning, clipping, formatting, or transforming the sensor data packets. At step 208, sensor data information received from the sensor data packets and contained in the sensor data queue may optionally be analyzed and portions of sensor data packets indicative of static environmental conditions may be deleted or otherwise removed. The gateway computing system 104 may be configured to analyze the received sensor data packets and/or to compare the received sensor data packets against one or more sensor data packets contained in the sensor data queue to determine sensor data packets or sensor information indicative of a static condition in the sensed environment. The gateway computing system 104 may detect or identify portions in the received sensor data packets indicative of static environmental conditions. For example, as discussed above, the gateway computing system 104 may detect or identify portions of received sensor data packets containing data that is indicative of a static condition in the environment, such as portions of received sensor data packets not indicative of a change in environmental condition but contained in a sensor data packet transmitting a change in another environmental condition or a sensor data packet generated and transmitted based upon time intervals. Additionally, the gateway computing system 104 may compare the recently received sensor data packets against previously received sensor data packets stored in the sensor data queue to determine whether some or all of the sensor data information in the recently received sensor data packets is the same as the sensor data information in the previously received sensor data packets stored in the sensor data queue, thereby indicating a static environmental condition. In some embodiments, the gateway computing system 104 may compare the recently received sensor data packets against the previously received sensor data packets based upon a predetermined tolerance to determine whether the sensed condition is static, as described above. The gateway computing system 104 may then be configured to delete or otherwise remove the portions of the sensor data packets which are indicative of static conditions. For example, the gateway computing system 104 may delete the portions of previously received data packets indicative of static conditions such that the recently received data packets remain in the sensor data queue.

At step 210, sensor data information received from the sensor data packets and contained in the sensor data queue may be analyzed and portions of sensor data packets containing irrelevant and/or redundant information may optionally be deleted or otherwise removed. The gateway computing system 104 may be configured to analyze and compare the sensor data packets contained in the sensor data queue to determine portions of sensor data containing irrelevant and/or redundant information in light of more recently received sensor data packets. For example, as discussed above, the gateway computing system 104 may detect or identify portions of sensor data packets contained in the sensor data queue containing sensor data information that is irrelevant or redundant in view of other sensor data information, such as when sensor data information in a previously received sensor data packet contained in the sensor data queue is indicative of a sensed change in an environmental condition that is less than a subsequent sensed change in the same environmental condition contained in a more recently received sensor data packet. Additionally, the gateway computing system 104 may detect or identify portions of sensor data packets contained in the sensor data queue in which previously received sensor data packets contained in the sensor data queue contain sensor data information that is negated by information of subsequent changes in the environment contained in subsequently received sensor data packets. In some embodiments, the gateway computing system 104 may compare the recently received sensor data packets against the previously received sensor data packets based upon a predetermined tolerance to determine whether the sensed condition is redundant or irrelevant, as described above. The gateway computing system 104 may then be configured to delete or remove the sensor data information contained in the sensor data packets which containing irrelevant and/or redundant information. For example, the gateway computing system 104 may delete the portions of previously received data packets which are irrelevant and/or redundant such that the recently received data packets remain in the sensor data queue.

In some embodiments, sensor data information and/or sensor data packets which would otherwise be deleted in step 208 or step 210, may not be deleted and may remain in the sensor data queue. For example, the gateway computing system 104 may be configured to retain sensor data packets in the sensor data queue such that sensor data packets received from sensors 102 are communicated to the centralized property management computing system 112 at periodic intervals, such as one or more times per day.

At step 212, one or more priority tags or labels are assigned to each of the sensor data packets in the sensor data queue. The gateway computing system 104 is configured to assign one or more priority tags or labels to each of the sensor data packets contained in the sensor data queue. The one or more priority tags or labels may be assigned based upon the relative importance or priority of the sensor data packet in relation to the other sensor data packets stored in the sensor data queue. As discussed above, the gateway computing system 104 may assign one or more priority labels to the sensor data packets based upon the contents, relevance, timing, and/or importance of the sensor data information contained in the sensor data packets, and/or other suitable factors to determine an overall priority for each of the sensor data packets. For example, the gateway computing system 104 may assign a first priority label to sensor data packets indicative of the type of condition sensed in the sensor data packet, a second priority label based upon an amount of sensed value change, and a third priority label based upon a delay or amount of time that the sensor data packet has remained in the sensor data queue. The gateway computing system 104 may assign relatively high first, second, and/or third priority tags to the sensor data packets that are desired to be transmitted from the gateway computing system 104 earlier and relatively low first, second, and/or third priority tags to the sensor data packets that may remain in the sensor data queue and may be transmitted later. For example, the gateway computing system 104 may assign priority labels such that urgent sensor data, such as sensor data indicative of a fire or flooding, is labeled with the highest priority and transmitted from the gateway computing system 104 as quickly as possible. The gateway computing system 104 may group or bucket the priority tags, such as into high, medium, and low priority tags. The gateway computing system 104 may assign each sensor data packet stored in the sensor data queue with each of the priority tags or the gateway computing system 104 may assign each sensor data packet with less than all of the priority tags. The gateway computing system 104 may then determine and assign an overall priority to each of the sensor data packets based on the assigned priority tags. Alternatively, the gateway computing system 104 may simultaneously weigh or evaluate the contents of each sensor data packets to determine and assign the overall priorities of each of the sensor data packets.

The gateway computing system 104 may be configured to assign the priority tags and/or overall priorities at one or more times. For example, the gateway computing system 104 may be configured to assign one or more priority tags and/or overall priorities upon receipt of the sensor data packets, upon receipt of one or more additional sensor data packets, at specified or set intervals, before transmission of an aggregate sensor data message, and/or after transmission of an aggregate sensor data message.

At step 214, an aggregate sensor data message is formed and/or generated. The gateway computing system 104 may form and/or generate the aggregate sensor data by combining or appending one or more sensor data packets stored in the sensor data queue based upon the one or more priority tags or labels and/or overall priorities assigned in steps 206, 208, and/or 210. For example, the gateway computing system 104 may combine or append the sensor data packets in the sensor data queue having the highest priority tags and/or priority labels into an aggregate sensor data message. In some embodiments, before the aggregate sensor data message is generated, the gateway computing system 104 may reorder or reorganize the sensor data packets stored in the sensor data queue based upon one or more of the assigned priority labels and/or overall priorities, such as ordering the sensor data packets in the queue such that the sensor data packets with the highest first, second, and/or third priority tags or the sensor data packets with the highest overall priorities are at the top of the queue. The aggregate sensor data message may contain any number of sensor data packets such that the aggregate sensor data message may be transmitted via the second communication protocol.

At step 216, the aggregate sensor data message is transmitted via a second communication protocol. The gateway computing system 104 is configured to transmit the generated aggregate data message via the second communication protocol that is different from the first communication protocol and having a transmission or coverage range larger than a transmission or coverage range of the first communication protocol. In some embodiments, the second communication protocol is a long-range wireless communication protocol. As described above, the second communication protocol may be a long-range radio communication protocol, having a range between about 0.1 and about 30 miles, such as between about 0.5 miles and about 2 miles. The second communication protocol may be capable of transmitting the aggregate sensor data message to a centralized property management computing system and/or network, as discussed below.

At step 218, sensor data packets in the sensor data queue which were included in the transmitted aggregate sensor data message may optionally be removed from the sensor data queue. The gateway computing system 104 may analyze the sensor data packets stored in the sensor data queue and/or compare the sensor data packets stored in the sensor data queue to the transmitted aggregate sensor data messages to determine which sensor data packets had been transmitted by the gateway computing system 104 in an aggregate sensor data message via the second communication protocol. For example, the gateway computing system 104 may compare the sensor data packets stored in the sensor data queue with the sensor data packets contained in the transmitted aggregate sensor data message and assign a tag that the one or more sensor data packets in the sensor data queue have been transmitted. In other embodiments, the gateway computing system 104 may compare the sensor data packets stored in the sensor data queue with sensor data information received by the centralized property management computing system and/or the network and assign a tag that the one or more sensor data packets in the sensor data queue have been transmitted and received by the centralized property management computing system and/or network. The gateway computing system 104 may then delete or otherwise remove the sensor data packets with assigned tags of transmission and/or receipt from the sensor data queue.

FIG. 4 shows steps according to a method 300 for prioritizing sensor data packets and generating an aggregate sensor data message. It will be appreciated that the illustrated method and associated steps may be performed in a different order, with illustrated steps omitted, with additional steps added, or with a combination of reordered, combined, omitted, or additional steps. The steps may be implemented in one or more computer readable instructions, such as by the gateway computing system 104.

At step 302, received sensor data packets are added or appended to or stored in a sensor data queue. The gateway computing system 104 receives sensor data information in the form of sensor data packets transmitted by one or more sensors 102 in an environment via a first communication protocol, such as a short-range wireless communication protocol. The sensor data packets may contain sensor data information relating to a sensed environment, such as a residence or building, and may relate to one or more conditions, such as temperature or humidity. The sensor data packets may also contain time stamps relating to the one or more conditions sensed in the environment.

At step 304, a first priority tag or label is assigned and/or applied to each of the sensor data packets contained in the sensor data queue based upon a sensed condition contained or indicated in the sensor data packet. As discussed above, the gateway computing system 104 may assign a first priority tag or label to one or more sensor data packets contained in the sensor data queue based upon the type of condition sensed in the sensor data packet with a relatively higher priority assigned to conditions requiring immediate action or attention from the property management system 100 or a user and a relatively lower priority assigned to conditions which do not require immediate attention or action from the property management system 100 or a user. For example, the gateway computing system 104 may assign a high first priority label to sensor data packets indicative of urgent property issues, such as fire or flooding, and may assign a low first priority label to sensor data packets indicative of less urgent environment changes, such as minor changes in temperature or humidity in the sensed environment. The gateway computing system 104 may assign the first priority labels according to multiple levels or buckets, such as according to high, medium, and low levels, or any other suitable classification.

At step 306, a second priority tag or label is assigned and/or applied to each of the sensor data packets contained in the sensor data queue based upon the amount of change value or values in the sensed conditions. As discussed above, the gateway computing system 104 may assign a second priority tag or label to one or more sensor data packets contained in the sensor data queue based upon an amount a sensed value included in the sensor data packet changed (e.g., the delta) with a relatively higher priority assigned to large changes in value and a relatively lower priority assigned to small or minor changes in value. For example, the gateway computing system 104 may assign a high second priority label to sensor data packets indicative of changes in temperature over 10 degrees and may assign a low second priority label to sensor data packets indicative of changes in temperature less than 0.2 degrees. The gateway computing system 104 may determine the amount a sensed value changed from the received sensor data packet(s), by comparing the recently received sensor data packet with one or more other sensor data packets contained in the sensor data queue, and/or by comparing the sensor data information contained in the sensor data queue to previous or historical sensor data information contained in the centralized property management computing system 112 and/or the storage 118, such as via the network 110. The gateway computing system 104 may assign the second priority labels according to multiple levels or buckets, such as according to high, medium, and low levels, or any other suitable classification.

At step 308, a third priority tag or label is assigned and/or applied to each of the sensor data packets contained in the sensor data queue based upon the delay in transmitting the sensor data packet and/or the amount of time the sensor data packet has remained in the sensor data queue without being transmitted. The gateway computing system 104 may determine the amount of time the sensor data packets have remained in the sensor data queue by comparing the current time to one or more time stamps contained in or assigned to the sensor data packets. As discussed above, the gateway computing system 104 may assign a third priority tag or label to one or more sensor data packets contained in the sensor data queue based upon the delay or amount of time that the sensor data packet has remained in the sensor data queue with a relatively higher priority assigned to sensor data packets that have remained in the sensor data queue and a relatively lower priority assigned to sensor data packets that have been recently received or stored in the sensor data queue. For example, the gateway computing system 104 may assign a high third priority label to sensor data packets that have been stored in the sensor data queue after multiple aggregate sensor data messages have been transmitted and may assign a low third priority label to sensor data packets that have been received or stored in the sensor data queue after the last aggregate sensor data message was transmitted. The gateway computing system 104 may assign the third priority labels according to multiple levels or buckets, such as according to high, medium, and low levels, or any other suitable classification.

Additional priority tags or labels may be assigned and/or applied to each of the sensor data packets contained in the sensor data queue based upon other factors or conditions. For example, additional priority tags or labels may be assigned and/or applied to each of the sensor data packets contained in the sensor data queue based upon the location of the sensor from which the sensor data packet was received, the sensitivity of the sensor from which the sensor data packet was received, the accuracy or precision of the sensor from which the sensor data packet was received, the transmission rate of the sensor from which the sensor data packet was received, and/or any other suitable factor or condition. Moreover, according to various examples, sensor type and/or data type can be used for prioritization. Further, it is contemplated that the gateway computing system 104 can perform data modification, and the prioritization can be based on such data modification. Pursuant to an illustration, the gateway computing system 104 can calculate a kilowatt/hour (hw/h) value based on data received from a sensor reporting a current value (e.g., amps) and the time between messages; yet, the claimed subject matter is not limited to the foregoing illustration.

At step 310, overall priorities may be assigned to each of the sensor data packets contained the sensor data queue. The gateway computing system 104 may weigh or evaluate one or more of the priority labels assigned in steps 304, 306, and 308 to determine an overall priority for each of the sensor data packets contained in the sensor data queue. The gateway computing system 104 may weight or value the assigned priority labels, such as the first, second, and/or third priority labels, according to any suitable algorithm or metric to determine the overall priorities such that the most important sensor data packets in the sensor data queue are assigned with the highest overall priorities. For example, the gateway computing system 104 may weight first priority labels indicative of fires or flooding the highest, weight high third priority labels the second highest, and weight high second priority labels the third highest. Alternatively, the gateway computing system 104 may determine and assign the overall priority for each of the sensor data packets in the sensor data queue by simultaneously weighting or evaluating the contents of each sensor data packet. The overall priorities may be assigned to the sensor data packets such that the sensor data packets with the most important information and/or the sensor data packages that have been held in the sensor data queue for the longest period of time are assigned the highest overall priorities.

At step 312, an aggregate sensor data message is generated from sensor data packets contained in the sensor data queue based upon the assigned priority tags or labels and/or overall priorities. The gateway computing system 104 may aggregate, append, or combine one or more sensor data packets in the sensor data queue based upon one or more of the assigned first, second, and/or third priority labels and/or overall priorities such that the sensor data packets with the highest assigned first, second, and/or third priority labels and/or overall priorities are included in the aggregate sensor data message. In some embodiments, the gateway computing system 104 reorders or reorganizes the sensor data packets contained in the sensor data queue based upon the first, second, and/or third priority labels and/or overall priorities, such as organizing the sensor data packets with the highest priority labels and/or overall priorities to be at the top of the queue, before generating the aggregate sensor data message. In other embodiments, the gateway computing system 104 identifies and aggregates or appends the sensor data packets with the highest priority labels and/or overall priorities into the aggregate sensor data message. The aggregate sensor data message may contain a number of sensor data packets such that the size of the combined sensor data packets may be transmitted in a single aggregate sensor data message via the second communication protocol. The generated aggregate sensor data message may then be transmitted, such as via a second communication protocol that is a long-range wireless communication protocol, such as a long-range radio transmission, as discussed above.

Referring back to FIG. 1, the system 100 may also include a centralized property management computing system 112 which includes a processor 114 and a memory 116 in data communication with one another. The processor 114 executes instructions that are stored in the memory 116. The instructions may be, for instance, instructions for implementing functionality as being carried out by one or more systems discussed below or instructions for implementing one or more of the methods described below. The processor 114 may be a GPU, a plurality of GPUs, a CPU, a plurality of CPUs, a multi-core processor, a controller, a micro-controller, a SOM, etc. The processor 114 may access the memory 116 by way of a system bus. In addition to storing executable instructions, the memory 116 may also store historical sensor data information, building or environment data, sensor data, data related to the type, accuracy, sensitivity, and location of sensors, and so forth. The centralized property management computing system 112 is configured to receive aggregate sensor data messages from the gateway computing system 104, store and analyze the sensor data information contained in the aggregate sensor data messages, generate one or more outputs indicative of detected conditions in an environment, and execute or cause to be executed one or more property management control operations in the environment. The centralized property management computing system 112 may also be in data communication with the gateway computing system 104, such as being within the transmission range or coverage area of the second communication protocol from the gateway computing system 104. The centralized property management computing system 112 may also be capable of receiving the aggregate sensor data messages from the gateway computing system 104 via the second communication protocol.

The system 100 may also include one or more networks 110 in data communication with the centralized property management computing system 112. Optionally, the network 110 may also be in data communication with the gateway computing system 104. The network 110 may be any suitable wired or wireless communication system which may permit data communication between device, computers, processors, hardware components, or other suitable components. For example, the network 110 may be the Internet, intranet, wired connection, or any other suitable means for enabling operable communication between devices, computers, processors, hardware components, or other suitable components. In one embodiment, the system 100 includes a base station remote from the sensed environment and the gateway computing system 104 which receives one or more transmitted aggregate sensor data messages from the gateway computing system 104 and uploads and/or transmits the aggregate sensor data messages to the one or more networks 110.

Bi-directional communication between the gateway computing system 104 and the centralized property management computing system 112 is employed in the system 100. For instance, point-to-point wireless communication can be utilized between the gateway computing system 104 and the centralized property management computing system 112. According to an illustration, the gateway computing system 104 can join an existing network (e.g., the network 110, a public network, a proprietary network, etc.). Data packets transmitted between the gateway computing system 104 and the centralized property management computing system 112 can be encrypted. Moreover, the sensors are setup and known by the gateway computing system 104. Thus, the sensors interface with the gateway computing system 104, and the gateway computing system 104 interfaces with the centralized property management computing system 112 (e.g., one gateway computing system 104 can be introduced to the centralized property management computing system 112 rather than a larger number of sensors being introduced to the centralized property management computing system 112).

The system 100 may also include a storage 118 for long term storage of sensor data information and information about one or more properties, such as the storage of historical sensor data information and/or historical sensor data packets, information about the sensors 102 in the environment, and/or the like. The storage 118 can also include sensor data (payload) and overhead, such as a source identifier, a destination identifier, and signal strength. The storage 118 may be any suitable data storage or memory device and may be in data communication with the centralized property management computing system 112. It is appreciated that the data communication between the centralized property management computing system 112 and the storage 118 may be in real time or near real-time. In some embodiments, the storage 118 is integrated with the centralized property management computing system 112. It is appreciated that the centralized property management computing system 112, processor 114, memory 116, and storage 118 may be configured as separate devices linked by a wireless or wired control signal, or integrated as a single device.

The centralized property management computing system 112 is configured to receive aggregate sensor data messages from the gateway computing system 104, process and analyze the sensor data information contained in the aggregate sensor data messages, generate an output indicative of the sensor data information contained in the aggregate sensor data messages, and execute or cause to be executed one or more property management control operations in the sensed environment. Optionally, the centralized property management computing system 112 may receive aggregate sensor data messages from the gateway computing system 104 via the network 110. The centralized property management computing system 112 may receive the aggregate sensor data messages and store the sensor information contained therein in the memory 116 and/or the storage 118 or append the sensor data information thereto. The centralized property management computing system 112 may extract the sensor data packets from the aggregate sensor data message received via the second communication protocol and append the sensor data packet information into a sensor data store contained in the memory 116 and/or storage 118. The processor 114 of the centralized property management computing system 112 is then configured to analyze or otherwise process the sensor information contained in the aggregate sensor data message to determine one or more conditions or changes in conditions in the sensed environment. The centralized property management computing system 112 may also compare the sensor information contained in the aggregate sensor data message with historical sensor data information stored in the storage 118 to compare or evaluate the current or updated conditions against historical sensor data information and/or conditions of the sensed environment. Based upon the sensor data information contained in the aggregate sensor data message, the centralized property management computing system 112 may generate an output indicative of the detected current and/or updated conditions in the sensed environment. Additionally, based upon the current and/or updated conditions in the sensed environment, the centralized property management computing system 112 may execute or cause to be executed one or more property management control operations, such as via a property controller, to execute a change in the sensed environment.

The system 100 may also include a property controller 120 in data communication with the network 110 and the centralized property management computing system 112, such as directly or via the network 110. The property controller 120 may be disposed in and/or capable of implementing changes in the sensed environment. The property controller 120 may be configured to implement one or more property management control operations in the sensed environment, such as within a residence or building, based on the sensor data information or user commands, as discussed below. For example, upon receipt of an output or command from the centralized property management computing system 112, the property controller 120 may implement one or more property management control operations. The property controller 120 may be integrated within or in data communication with one or more controls or devices within the environment such that property controller 120 may execute or implement property management control operations including, but not limited to, increasing/decreasing the air-conditioning, increasing/decreasing the heat, turning on/off lights, turning on/off water, locking/unlocking doors, turning on/off electricity, turning on/off a humidifier or dehumidifier, directing or manipulating an HVAC system, or other suitable actions. Bi-directional communication between the property controller 120 and the centralized property management computing system 112 is employed in the system 100. For instance, point-to-point wireless communication can be utilized between the property controller 120 and the centralized property management computing system 112.

The system 100 may further include a user interface 122 in data communication with the network 110, the centralized property management computing system 112, and the property controller 120. The user interface 122 may be a graphical or digital representation generated by the centralized property management computing system 112 such that a user (e.g., a home or building owner or manager) may view and/or interact with the property controller 120 and/or the property controller 120 via the user interface 122. The user interface 122 may be capable of being displayed on any digital display such as, but not limited to, a LCD, LED, OLED, monitor, television, cellular telephone, or tablet computer.

The centralized property management computing system 112 and/or the property controller 120 may generate windows, images, prompts, commands, menus, forms, interactive modules, or other displays which may be displayed on or in the user interface 122 and viewed and/or interacted with by a user. The centralized property management computing system 112 may generate one or more displays in the user interface 122 indicative of the real time, near real-time, and/or historical conditions sensed in the environment, such as a building or residence. In several exemplary embodiments, the user interacts with, or edits, or displays, or performs actions with, or views, or adds/edits/replaces information on the user interface 122. Based upon received sensor data packets or information, the centralized property management computing system 112 and/or user interface 122 may generate an alert or prompt in the user interface 122. For example, based upon sensor data information indicative of a fire or flooding, the centralized property management computing system 112 and/or user interface 122 may generate an alert in the user interface 122 indicative of the fire or flooding, or based upon sensor data information indicative of increased temperature in the environment, the centralized property management computing system 112 and/or user interface 122 may generate a prompt in the user interface 122 asking whether the user would like the centralized property management computing system 112 and/or the property controller 120 to execute a property management control operation in the environment, such as increasing the air conditioning. Further, the user interface 122 may include options for user input allowing a user to cause the centralized property management computing system 112 and/or property controller 120 to execute a property management control operation. For example, upon indication by a user in the user interface 122, the centralized property management computing system 112 and/or the property controller 120 may take one or more property management control operations such as, but not limited to, increasing the air conditioning, increasing the heat, turning on/off the water, turning on/off the lights, or sealing off a portion of the house or building.

In some embodiments, the gateway computing system 104 is configured to receive signals from the centralized property management computing system 112, the property controller 120, and/or the user interface 122, to communicate with one or more sensors 102, and/or to implement changes in the sensed environment. The gateway computing system 104 may receive commands from the centralized property management computing system 112, the property controller 120, and/or the user interface 122 and be configured to implement one or more property management control operations in the sensed environment based upon the received commands. The gateway computing system 104 may be integrated within or in data communication with one or more controls or devices within the environment such that gateway computing system 104 may execute or implement property management control operations including, but not limited to, increasing/decreasing the air-conditioning, increasing/decreasing the heat, turning on/off lights, turning on/off water, locking/unlocking doors, turning on/off electricity, turning on/off a humidifier or dehumidifier, directing or manipulating an HVAC system, or other suitable actions. Bi-directional communication between the gateway computing system 104 and the centralized property management computing system 112 is employed in the system 100. For instance, point-to-point wireless communication, such as long-range radio transmission, can be utilized between the gateway computing system 104 and the centralized property management computing system 112.

The gateway computing system 104 may also be configured execute or cause to be executed one or more changes for one or more sensors 102. By way of non-limiting example, the gateway computing system 104 may generate an output command to be received by one or more sensors 102. The output command generated by the gateway computing system 104 may be sent to one of the sensors 102, such as a thermostat, to execute or cause to be executed one or more changes for the sensor 102, such as to override a change made locally at the sensor 102.

It is appreciated that the sensors 102, gateway computing system 104, network 110, centralized property management computing system 112, storage 118, property controller 120, and/or user interface 122 may be configured in combination with another or other similar devices configured to detect, transmit, store, display, process, evaluate, or control one or more conditions in an environment, such as a residence or building.

In certain embodiments, the property management system 100 may further include additional components, including but not limited to, additional computing devices (e.g., servers, workstations, client workstations, routers, switches, controllers and various computing devices) and/or mobile devices. Additionally, while illustrated as a single system, it is to be understood that the property management system 100 may be a distributed system. Thus, for instance, several devices may be in communication by way of a network connection and may collectively perform tasks described as being performed by the property management system 100.

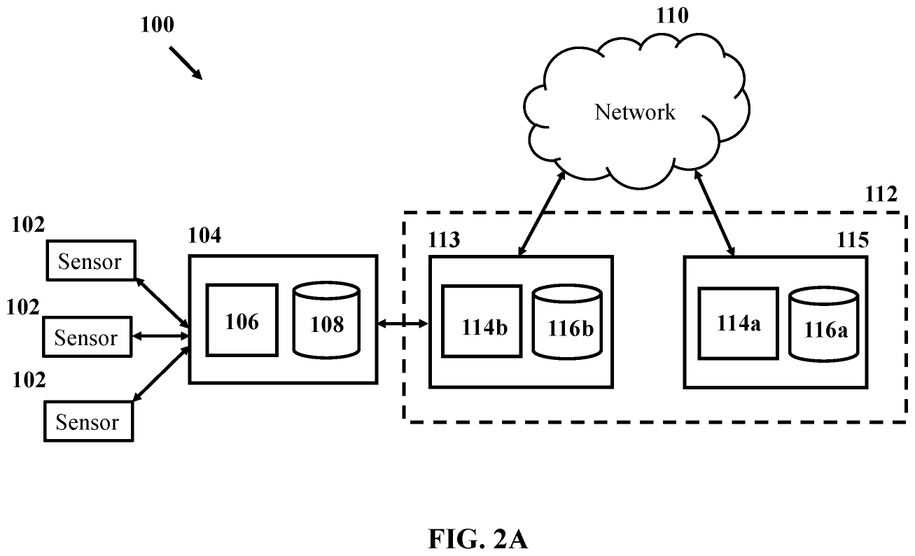

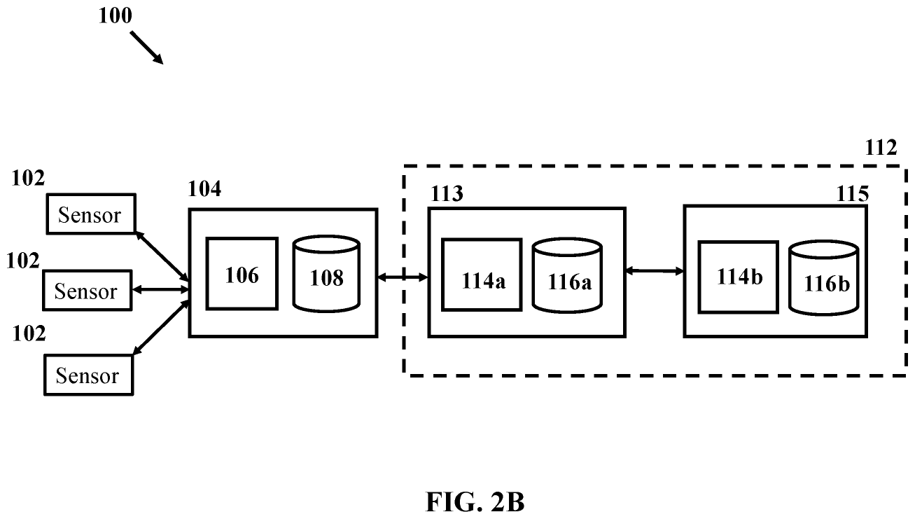

Referring now to FIGS. 2A and 2B, the centralized property management computing system 112 may include a remote gateway 113 and a monitoring and control system 115. The remote gateway 113 may be within the transmission range or coverage area of the second communication protocol from one or more gateway computing systems 104. The monitoring and control system 115 may be located near the remote gateway 113 or may be located remote from the remote gateway 114. The remote gateway 113 may be configured to receive aggregate sensor messages from the gateway computing system 104 and the monitoring and control system 115 may be configured to analyze the information contained in the aggregate sensor messages to monitor and control the sensed environment, as described above.

The remote gateway 113 may include a first processor 114a and a first memory 116a in data communication with one another. The monitoring and control system 115 may include a second processor 114b and a second memory 116b in data communication with one another. The first and second processors 114a, 114b may be substantially similar to the processor 114 described in FIG. 1. The first and second memories 116a, 116b may be substantially similar to the memory 116 described in FIG. 1. In some embodiments, the second memory 116b may store historical sensor data information, building or environment data, sensor data, data related to the type, accuracy, sensitivity, and location of sensors, and so forth.

The remote gateway 113 is configured to receive aggregate sensor data messages from one or more gateway computing systems 104 via the second communication protocol. In the illustrated embodiment, the remote gateway 113 is shown to receive aggregate sensor data messages from one gateway computing system 104. However, it will be understood that the system 100 may have other configurations. For example, the remote gateway 113 may have a one-to-many connection and may receive aggregate sensor data messages from more than one gateway computing systems 104. The remote gateway 113 is also configured to output the received aggregate sensor data messages to the monitoring and control system 115. In some embodiments, the remote gateway 113 is configured to process or pre-process the received aggregate sensor data message before output to the monitoring and control system 115.

Bi-directional communication between the gateway computing system 104 and the remote gateway 113 may employed in the system 100. For instance, point-to-point wireless communication can be utilized between the gateway computing system 104 and the remote gateway 113, as described above. Data packets transmitted between the gateway computing system 104 and the remote gateway 113 can be encrypted.

The monitoring and control system 115 is configured to receive the aggregate sensor data messages from the remote gateway 113. The monitoring and control system 115 is also configured to store and analyze the sensor data information contained in the aggregate sensor data messages, generate one or more outputs indicative of detected conditions in an environment, and execute or cause to be executed one or more property management control operations in the environment, as described above. The monitoring and control system 115 is configured to receive aggregate sensor data messages from the gateway computing system 104, process and analyze the sensor data information contained in the aggregate sensor data messages, generate an output indicative of the sensor data information contained in the aggregate sensor data messages, and execute or cause to be executed one or more property management control operations in the sensed environment.

The monitoring and control system 115 may be configured to process and analyze the sensor data information contained in the aggregate sensor data messages, generate an output indicative of the sensor data information contained in the aggregate sensor data messages, and execute or cause to be executed one or more property management control operations in the sensed environment. The monitoring and control system 115 may receive the aggregate sensor data messages and store the sensor information contained therein in the second memory 116b or append the sensor data information thereto. In some embodiments, the monitoring and control system 115 may extract the sensor data packets from the aggregate sensor data message received from the remote gateway 113 and append the sensor data packet information into a sensor data store contained in the second memory 116b. In other embodiments, the remote gateway 113 may extract the sensor data packets from the aggregate sensor data message received via the second communication protocol and transmit the extracted information to the monitoring and control system 115, as described below.

The second processor 114b of the monitoring and control system 115 may then be configured to analyze or otherwise process the sensor information contained in the aggregate sensor data message to determine one or more conditions or changes in conditions in the sensed environment. The monitoring and control system 115 may also compare the sensor information contained in the aggregate sensor data message with historical sensor data information to compare or evaluate the current or updated conditions against historical sensor data information and/or conditions of the sensed environment. Based upon the sensor data information contained in the aggregate sensor data message, the monitoring and control system 115 may generate an output indicative of the detected current and/or updated conditions in the sensed environment. Additionally, based upon the current and/or updated conditions in the sensed environment, the monitoring and control system 115 may execute or cause to be executed one or more property management control operations, such as via a property controller, to execute a change in the sensed environment. Further, it will be understood that one or more functions described as being implemented by the monitoring control system 115 may be implemented by the remote gateway 113.

As shown in FIG. 2A, the remote gateway 113 is in bi-directional data communication with the monitoring and control system 115 via the network 110. The remote gateway 113 may receive aggregate sensor data messages from one or more gateway computing systems 104 via the second communication protocol. The remote gateway 104 may then transmit the aggregate sensor data messages or the information contained therein to the network 110. The monitoring and control system 115 may receive the aggregate sensor data messages or the information contained therein from the network 110. The monitoring and control system 115 may then be configured to analyze or otherwise process the sensor information contained in the aggregate sensor data message to determine one or more conditions or changes in conditions in the sensed environment, as described above. Based upon the sensor data information contained in the aggregate sensor data message, the monitoring and control system 115 may generate an output indicative of the detected current and/or updated conditions in the sensed environment. Additionally, based upon the current and/or updated conditions in the sensed environment, the monitoring and control system 115 may execute or cause to be executed one or more property management control operations, such as via the remote gateway 104 and/or the gateway computing system 104, to execute a change in the sensed environment.

As shown in FIG. 2B, the remote gateway 113 is directly in bi-directional data communication with the monitoring and control system 115, such as via a local network. The remote gateway 113 may receive aggregate sensor data messages from one or more gateway computing systems 104 via the second communication protocol. The remote gateway 104 may then transmit the aggregate sensor data messages or the information contained to the monitoring and control system 115. The monitoring and control system 115 may then be configured to analyze or otherwise process the sensor information contained in the aggregate sensor data message to determine one or more conditions or changes in conditions in the sensed environment, as described above. Based upon the sensor data information contained in the aggregate sensor data message, the monitoring and control system 115 may generate an output indicative of the detected current and/or updated conditions in the sensed environment. Additionally, based upon the current and/or updated conditions in the sensed environment, the monitoring and control system 115 may execute or cause to be executed one or more property management control operations, such as via the remote gateway 113 and/or the gateway computing system 104, to execute a change in the sensed environment. For example, the monitoring and control system 115 may be in bi-direction communication with the gateway computing system 104 via the remote gateway 113. In some embodiments, the monitoring and control system 115 may also be in bi-directional communication with the gateway computing system 104, such as via long-range radio transmission.

While not shown in the property management system 100 of FIGS. 2A and 2B, either or both of the property management systems 100 of FIGS. 2A and 2B may include one or more property controllers 120 and/or one or more user interfaces 122 as shown in FIG. 1. Additionally, either or both of the remote gateway 113 and the monitoring and control system 115 may include or be in data communication with a storage 118 as described in FIG. 1. The storage(s) 118 may be configured for long term storage of sensor data information and information about one or more properties, such as the storage of historical sensor data information and/or historical sensor data packets, information about the sensors 102 in the environment, and/or the like. The storage(s) 118 can also include sensor data (payload) and overhead, such as a source identifier, a destination identifier, and signal strength. The storage 118 may be any suitable data storage or memory device and may be in data communication with the centralized property management computing system 112.

In the illustrated embodiments, the monitoring and control system 115 is in data communication with one remote gateway 113. However, it will be understood that the monitoring and control system 115 may be connected to more than one remote gateway 113. For example, the monitoring and control system 115 may have a one-to-many connection to multiple remote gateways 113, which may each be connected to one or more gateway computing systems 104.

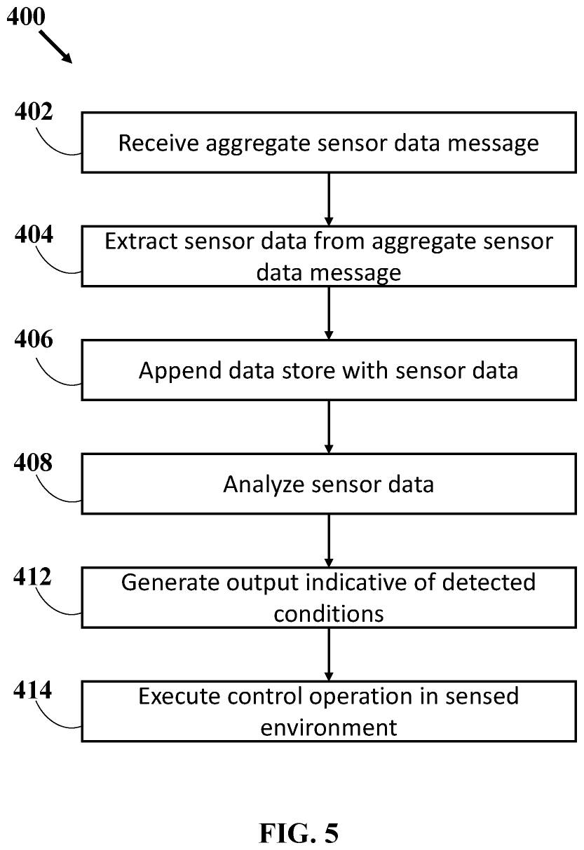

FIG. 5 shows steps according to a method 400 for controlling a property based upon sensor information. It will be appreciated that the illustrated method and associated steps may be performed in a different order, with illustrated steps omitted, with additional steps added, or with a combination of reordered, combined, omitted, or additional steps. The steps may be implemented in one or more computer readable instructions, such as by the centralized property management computing system 112 and/or the property controller 120. Moreover, the acts described herein may be computer-executable instructions that can be implemented by one or more processors and/or stored on a computer-readable medium or media. The computer-executable instructions can include a routine, sub-routine, programs, a thread of execution, and/or the like. Still further, the results of acts of the methodologies can be stored in a computer-readable medium displayed on a display device, and/or the like.

At step 402, one or more aggregate sensor data messages containing sensor data packets relating to a sensed environment, such as a house or building, are received. The centralized property management computing system 112 may receive the aggregate sensor data message directly from the gateway computing system 104 via the second communication protocol, such as via a long-range wireless communication protocol. Alternatively, the centralized property management computing system 112 may receive the aggregate sensor data messages via the network 110 after the aggregate sensor data message is transmitted to a base station remote from the sensed environment via the second communication protocol and uploaded or transmitted to the one or more networks 110, such as described below.

At step 404, sensor data packets and/or sensor data information is extracted from the aggregate sensor data message. The centralized property management computing system 112 may extract the sensor data packets contained in the aggregate sensor data message. The centralized property management computing system 112 may extract each of the sensor data packets from the aggregate sensor data message or may extract the sensor data information contained in the sensor data packets.

At step 406, a data store is appended to include the sensor data packets and/or sensor data information extracted from the aggregate sensor data message. The centralized property management computing system 112 may store and/or append the sensor data information and/or the sensor data packets from the aggregate sensor data message into a data store in the memory 116 of the centralized property management computing system 112 or in the storage 118.

At step 408, the sensor data information and/or the sensor data packets information contained in the sensor data store are analyzed. The centralized property management computing system 112 may process and analyze the sensor data packets and/or sensor data information stored in the sensor data store to determine the current or updated conditions in the sensed environment. The centralized property management computing system 112 may also compare the sensor data information contained in the sensor data store with historical sensor data information stored in the storage 118 to determine the relative importance of the conditions reflected in the current and/or updated sensor data information.

At step 410, an output indicative of detected or updated conditions in the sensed environment is generated. The centralized property management computing system 112 may generate an output based upon one or more received aggregate sensor data messages indicative of the current and/or updated conditions in the sensed environment. For example, as discussed above, the centralized property management computing system 112 may generate an output indicative of the temperature, humidity, occupancy, air quality, presence of fire or water, electrical usage, or any other condition relating to the conditions of the sensed environment. The generated output may be displayed in the user interface 122 as a graphical or digital representation of the current and/or updated sensor data information of the sensed environment such that a user (e.g., a home or building owner or manager) may view the status of the conditions in the sensed environment in real time or near real-time. Additionally, the generated output in the user interface 122 may prompt the user to execute a property management control operation in the sensed environment. For example, when the generated output is indicative of an increased temperature in the sensed environment, the user interface 122 may prompt the user to increase the air conditioning in the sensed environment.

At step 412, a property management control operation is executed in the sensed environment. The centralized property management computing system 112 and/or the property controller 120 may execute one or more property management control operations in the sensed environment based on the sensed current and/or updated conditions in the environment. For example, as discussed above, the centralized property management computing system 112 may execute or cause the property controller 120 to execute a property management control operation to change or otherwise control the conditions in the sensed environment, such as increasing/decreasing the air-conditioning, increasing/decreasing the heat, turning on/off lights, turning on/off water, locking/unlocking doors, turning on/off electricity, turning on/off a humidifier or dehumidifier, directing or manipulating an HVAC system, or other suitable actions.

While the embodiments discussed herein have been related to the systems and methods discussed above, these embodiments are intended to be exemplary and are not intended to limit the applicability of these embodiments to only those discussed set forth herein. While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gateway computing system for use in a property management system, the gateway computing system comprising:
a processor that is configured to perform acts comprising;
receiving sensor data packets via a first communication protocol;
storing the sensor data packets in a sensor data queue;
assigning a priority label to each sensor data packet stored in the sensor data queue based upon the contents of the sensor data packets;
generating an aggregate sensor data message by appending sensor data packets stored in the sensor data queue based upon the priority labels of the sensor data packets; and
transmitting the aggregate sensor data message via a second communication protocol, wherein the first communication protocol is different from the second communication protocol.

2. The gateway computing system of claim 1, wherein the first communication protocol is a short-range radio protocol.

3. The gateway computing system of claim 1, wherein the second communication protocol is a long-range radio protocol.

4. The gateway computing system of claim 1, wherein the processor is further configured to remove sensor data packets indicative of a static condition in an environment from the sensor data queue.

5. The gateway computing system of claim 1, wherein the processor is further configured to remove sensor data packets transmitted in aggregate sensor data messages from the sensor data queue.

6. The gateway computing system of claim 1, wherein the priority label is assigned based upon a type of sensed condition in each sensor data packet.

7. The gateway computing system of claim 1, wherein the priority label is assigned based upon an amount of time each sensor data packet has been stored in the sensor data queue.

8. A method for transmitting sensor data packets for use in a property management system, the method comprising the steps:
receiving a plurality of sensor data packets via a first communication protocol;
storing the plurality of sensor data packets in a sensor data queue;
forming an aggregate sensor data message comprising at least two of the plurality of sensor data packets; and
transmitting the aggregate sensor data message via a second communication protocol;
wherein the first communication protocol has a first coverage range and the second communication protocol has a second coverage range, the second coverage range being larger than the first coverage range.

9. The method of claim 8, wherein the plurality of sensor data packets are received from a plurality of sensors.

10. The method of claim 8, further comprising the step of assigning a priority label to each of the plurality of sensor data packets based upon the contents of the sensor data packets.

11. The method of claim 8, wherein the second communication protocol is a long-range radio transmission.

12. The method of claim 8, wherein the steps are implemented by a gateway computing system.

13. A method for transmitting sensor data packets for use in a property management system, the method comprising the steps:
receiving sensor data packets via a first communication protocol;
storing the sensor data packets in a sensor data queue;
assigning a priority label to each sensor data packet stored in the sensor data queue based upon the contents of the sensor data packets;
generating an aggregate sensor data message by appending sensor data packets stored in the sensor data queue based upon the priority label of the sensor data packets; and
transmitting the aggregate sensor data message via a second communication protocol;
wherein the second communication protocol is different from the first communication protocol.

14. The method of claim 13, wherein the first communication protocol is a short-range radio transmission.

15. The method of claim 13, wherein the second communication protocol is a long-range radio transmission.

16. The method of claim 13, further comprising the step of removing the sensor data packets contained in the aggregate sensor data message from the sensor data queue.

17. The method of claim 13, further comprising the step of removing sensor data packets containing sensor data information indicative of a static condition from the sensor data queue.

18. The method of claim 13, wherein the priority label is assigned based upon a type of sensed condition in each sensor data packet.

19. The method of claim 13, wherein the priority label is assigned based upon an amount a sensed value in each sensor data packet changed.

20. The method of claim 13, wherein the priority label is assigned based upon an amount of time each sensor data packet has been stored in the sensor data queue.
